(19) United States
(12) Patent Application Publication
(10) Pub. No.: US 2013/0198762 A1
(43) Pub. Date: Aug. 1, 2013

(54) System and Method for Providing Customized Feedback to a User

(71) Applicants: Ronald Charles Thorpe, Richmond, KY (US); Eric Wayne McCann, Georgetown, KY (US); Randy Allen O'Neal, Georgetown, KY (US); Steven Brian Rogers, Lexington, KY (US)

(72) Inventors: Ronald Charles Thorpe, Richmond, KY (US); Eric Wayne McCann, Georgetown, KY (US); Randy Allen O'Neal, Georgetown, KY (US); Steven Brian Rogers, Lexington, KY (US)

(21) Appl. No.: 13/359,136

(22) Filed: Jan. 26, 2012

(51) Int. Cl. G06F 9/46

(52) U.S. Cl. 719/318

(57) ABSTRACT

A method of providing customized feedback to a user based upon user authentication and/or user identity. The method includes receiving authentication information from the user at a device, determining one or more customized feedback associated with the user based upon the authentication information, and providing at least one of the one or more customized feedback to the user in response to an occurrence of an event relating to functions of the device.

### CROSS REFERENCE TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure generally relates to customization of feedback, and, more particularly, to systems and methods that provide a user with customized feedback based on user authentication.

2. Description of the Related Art

Providing feedback during operation of a device is one method for ensuring a positive user experience. Feedback is generally used to provide information to a user, such as when acknowledging user-initiated actions, confirming the user's input or selection, and providing status reports, error and/or warning messages and instructions. Feedback may be provided in various forms perceptible to the human senses including simple visual signals, such as beacons and graphical or text displays, and audible signals such as interactive voice responses, beeps or other audible sounds. Feedback may also be tactile, such as through the use of haptic technology. Devices, such as printers, copiers, scanners, facsimile machines or multifunction devices, often provide feedback through a device user interface. The user interface may include a display screen for providing feedback in the form of images, videos and/or text display messages.

Typically, devices are configured by their manufacturers to contain a static set of preset feedback information for all users. These devices may detect the occurrence of events or conditions and may react accordingly by providing preset feedback information to the user. However, preset feedback information may still present challenges to some users because devices may fail to provide features that take into account the identity or abilities of a particular user when providing the feedback. A user having limited or no technical background on the device, for example, may not be able to fully comprehend the feedback information, especially when the feedback contains highly technical information. As a further example, users with visual and/or physical impairments may not be able to perform actions and/or may have difficulty performing the actions required by the feedback information, such as replacing cartridges or removing jammed paper.

Additionally, devices typically do not provide customized feedback based on user authentication. Rather, known methods of providing customized content or feedback store the customized content or feedback on the device used to perform the authentication. For example, customized content or feedback may be stored in proximity cards along with the user's authentication data or information. Thus, such content or feedback is stored for each individual, and members of a group having the same rights, privileges or abilities are unable to share the same customized content or feedback.

Accordingly, there is a need for an improved method and system that customizes user experiences with a device.

### SUMMARY

According to one example embodiment of the present disclosure, there is provided a method for providing customized feedback to a user. An intelligent device may receive authentication information from the user, determine one or more customized feedback associated with the user based upon the authentication information, and provide at least one of the one or more customized feedbacks to the user in response to an occurrence of an event relating to functions of the device.

In one aspect, the intelligent device may store at least one set of customized feedback messages in a storage medium. The intelligent device may obtain a characteristic of the user operating the intelligent device and determine whether the obtained characteristic of the user corresponds to at least one characteristic specified in a distinct one of a plurality of stored user data. Each stored user data may include a unique set of customized feedback messages programmed to override default feedback messages upon occurrences of events relating to functions of the device. In response to a positive determination, the intelligent device may communicate with the user using customized feedback messages included in the distinct user data to which the user is determined to be associated with such that output feedback of the device is dependent on the characteristic of the user operating the device.

In another example embodiment, the present disclosure relates to a system including a storage medium for storing a plurality of default feedback information and an input mechanism for accepting at least one customized feedback information to be stored within the storage medium. The system may also include a processor for selecting one of the at least one customized feedback information based upon a user credential and outputting the at least one customized feedback information to the user upon an occurrence of an event within a device.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is a block diagram depicting one example embodiment of an intelligent device.

FIG. 2 is a flowchart illustrating one example embodiment of a method of providing customized feedback to a user of the intelligent device of FIG. 1.

### DETAILED DESCRIPTION OF THE DRAWINGS

The following description and drawings illustrate example embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the description below.

These computer program instructions may also be stored in a non-transitory computer-readable memory that may direct a computer or other programmable data processing apparatus to function in a particular manner, such that the instructions stored in the computer-readable memory produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are systems and methods for providing customized feedback to a user based on user identity. Feedback may be provided whenever a device needs to communicate information to a user. Feedback may include information relating to operations and/or functions of the device. Feedback may be provided to acknowledge user-initiated actions, confirm the user's input or selection, notify the user of device or job status, conditions, errors and/or warning messages or instructions. For example, if a print job requires plain paper for a printing operation and the media tray is loaded with legal size paper, a user may receive audio or visual feedback stating “Please load tray 1 with A4 size plain paper.” Other examples of feedback may include, but are not limited to, messages such as “Tray 2 not inserted properly,” “Black cartridge low,” “Replace fuser,” “Print job complete,” etc. To ensure a more positive user experience, it may be desirable to provide feedback that is customized and comprehensible to the user operating and/or accessing the device. Customized feedback may also be used to extend or enhance preset feedback and ensure accessibility to all users, including users with disabilities, by employing additional components and/or methodologies.

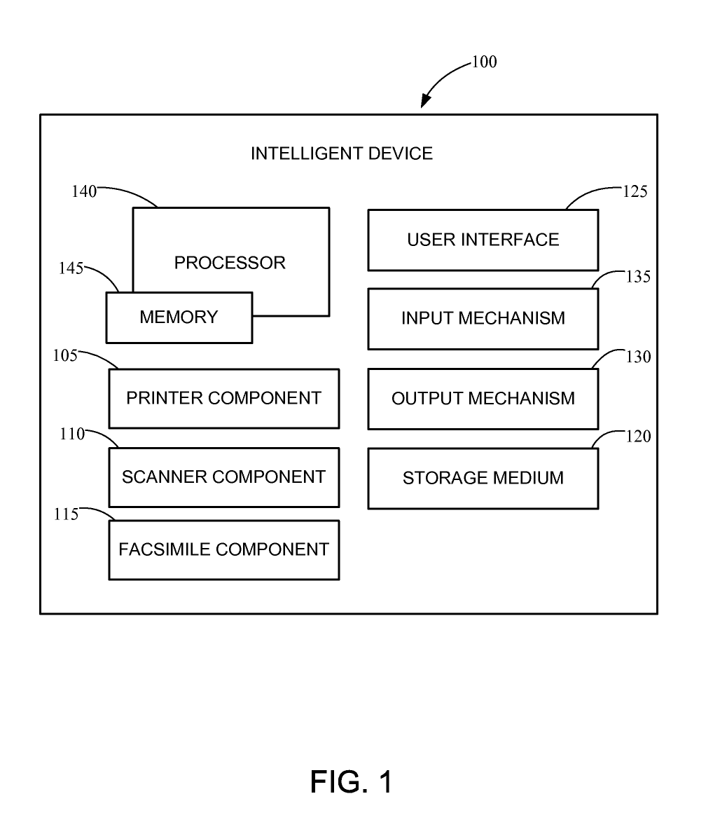

Referring now to the drawings, and particularly to FIG. 1, there is shown a block diagram depicting an intelligent device 100 used in association with the present disclosure. Intelligent device 100 may be a multi-function device and may include a printer component 105, a scanner component 110 and/or a facsimile component 115 for performing the functions of printing, copying, scanning and/or faxing. In one alternate example embodiment, intelligent device 100 may be a single function device such as a printer, copier, scanner or facsimile machine. In another example embodiment, intelligent device 100 may be any type of equipment, instrument, machine, or device with internal computing capability.

Intelligent device 100 may also include a storage medium 120, such as a hard drive, flash memory, read-only memory (RAM), or any other storage device capable of storing data. Storage medium 120 may be used to store a static set of default feedback information. Default feedback information may include standard, default or preset responses communicated by default to a user upon an occurrence of a particular function, event or condition at intelligent device 100. Customized feedback information may also be stored in storage medium 120. Customized feedback information may be provided by a user or administrator of intelligent device 100 and may be provided in addition to or in lieu of a corresponding default feedback associated with a particular function, event or condition. In some alternate example embodiments, customized feedback information, along with one or more user information associated with the customized feedback, may be stored remotely over the Internet or in the cloud on a server, a USB drive, an external hard drive, or other storage location external to intelligent device 100.

Intelligent device 100 may include a user interface 125, such as a graphical user interface, a character display, or any other display mechanism for displaying information to a user. Intelligent device 100 may further include an output mechanism 130, such as an audio speaker, tactile device, or any other component capable of communicating information and/or feedback to a user in various formats.

Intelligent device 100 may also include an input mechanism 135 for receiving user input. Input mechanism 135 may include one or more user selectable buttons, a keyboard, a mouse or any other component for receiving user inputs. In one alternate example embodiment, the user interface 125 and input mechanism 135 may be a single component, such as a touch screen display. A user may have access and/or permission to input customized feedback information at intelligent device 100 using input mechanism 135. For example, user may create unique feedback for each condition or event relating to an operation and/or function of intelligent device 100.

Customized feedback may be provided to a user via user interface 125 and/or output mechanism 130. In one aspect, customized feedback may be provided in the form of text-based messages, graphical images, or video clippings via a display screen of user interface 125. In another aspect, visual signals may be given via one or more single or multi-colored lights or light emitting diodes (LEDs). In yet another aspect, feedback may be provided in the form of audible messages through one or more audio speakers of output mechanism 130, such as beeps or other audio indicators, recorded audio clips or messages generated by a speech synthesizer. In still another aspect, feedback may be tactile in form such that forces, vibrations, or motions are applied to deliver feedback information to the user. For example, a data stream feedback may be provided to a tactile device, such as an articulated Braille display device, to deliver feedback information to a visually impaired user.

Intelligent device 100 may also include a processor 140 for executing instructions which interpret command data or user inputs and execute or carry out an action corresponding to the command data. Processor 140 may include a processor unit (not shown) and associated memory 145. In some example embodiments, processor may be formed as one or more Application Specific Integrated Circuits (ASICs). Memory 145 may be any memory device convenient for use with and capable of communicating with processor 140.

Processor 140 may communicate with printer component 105. Processor 140 may process print data and operate printer component 105 during the printing of the data onto a sheet of media. Printer component 105 may include any of a variety of different types of printing mechanisms including, but not limited to, dye-sublimation, dot-matrix, inkjet and laser. Printer component 105 may include a carriage for holding at least one print cartridge or tank, which houses ink or toner.

In one example aspect, intelligent device 100 may be configured to include one or more setup options that will allow the user to modify a default feedback for a particular event and/or input customized feedback information using input mechanism 135. For example, a feedback placeholder may be provided on user interface 125 of intelligent device 100 to allow the user to enter content of a customized feedback, and the user may make use of a program or application running on intelligent device 100 to set or create customized feedback for a particular event or condition.

In another example aspect, the user may enter customized feedback information from an external device (not shown) connected to intelligent device 100. Examples of external devices may include, but are not limited to, a host computer, a workstation, a laptop, a mobile phone, a personal digital assistant, a tablet or any other device that can actively communicate with intelligent device 100. For example, a user may make use of an external client program operating in association with intelligent device 100 to set or create customized feedback for a particular event or condition. Intelligent device 100 may receive the customized feedback information and store the customized feedback information within storage medium 120 for use as a response when the associated condition or event occurs.

In yet another example embodiment, customized audio feedback messages may be provided by the user to accompany or replace default feedback. For example, an audible message such as “out of paper” may accompany a displayed “out of paper” message when a media tray becomes empty. In one example aspect, intelligent device 100 may be equipped with a built-in microphone to capture customized audio feedback messages. In one alternative example aspect, the user may record the customized audio messages on a host computer, a mobile phone, or any other recording device and upload the recorded audio messages into intelligent device 100 along with the information necessary to associate the messages with the user and conditions or events. In still another alternative example aspect, intelligent device 100 may limit or restrict the input of customized feedback information and configuration of intelligent device 100 to a system administrator.

It will be appreciated any application, method or technique capable of generating feedback may be used to generate the customized feedback or files containing the customized feedback information and upload the feedback or files to the target storage area in intelligent device 100.

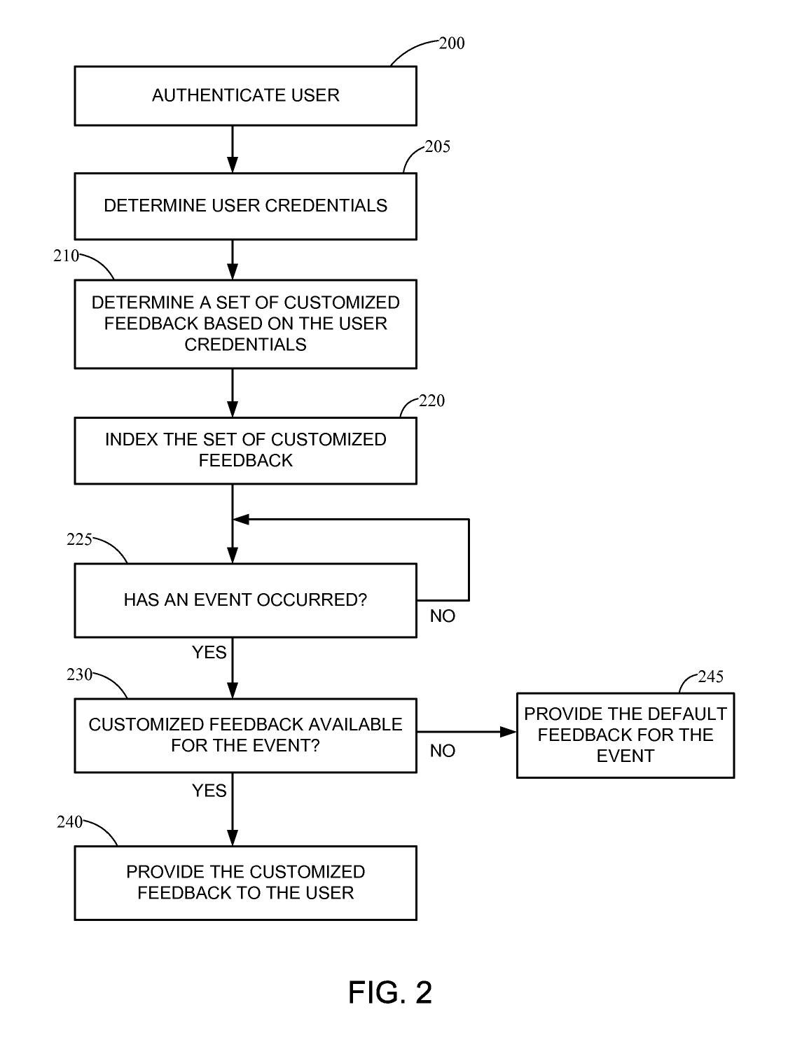

FIG. 2 illustrates one example method of providing customized feedback to a user. The start of the process is shown in block 200, where intelligent device 100 may authenticate a user to ensure secure access to intelligent device 100. The user may be authenticated passively by means of a proximity device, such as a Bluetooth device, an RFID device, a proximity card, or the like. In some alternate example embodiments, the user may be authenticated by an active means which requires user interaction with intelligent device 100 such as through a card reader, a barcode reader, a fingerprint reader or other biometric device, a USB drive or through the user entering credentials via input mechanism 135. It will be appreciated by those skilled in the art that any method of authentication may be utilized.

At block 205, processor 140 may compile a set of credentials received during the authentication process to represent the identity of the current user. In one example embodiment, the set of credentials may include one or more characteristics or attributes of the user including, but are not limited to, personal information such as the user's name, age, contact information, nationality, spoken languages, education, gender, date of birth and/or other demographic data. Credentials may also include any handicaps or physical disabilities or limitations of the user, such as impaired hearing, impaired sight, color blindness, etc.

At block 210, processor 140 may use the user credentials to determine whether or not one or more customized feedback information stored within storage medium 120 is associated with the authenticated user. In some alternative example embodiments, processor 140 may access a remote or external storage location, such as the Internet cloud, a server, a USB drive or an external hard drive, where customized feedback information may be stored. In one example aspect, intelligent device 100 may be configured to first read the local storage medium 120 before looking at another external storage location for customized feedback data. It will be appreciated by those of ordinary skill in the art that any hierarchical order of accessing storage devices and/or locations may be utilized.

In one example embodiment, intelligent device 100 may normally support a base language and a subset of major languages. By offering easy customization of feedback, intelligent device 100 may provide a way to support dialects, linguistic colloquialisms or non-supported languages without changing the language settings of intelligent device 100. By taking into account the nationality and/or spoken languages of the authenticated user after authentication, for example, intelligent device 100 may be able to look up one or more customized feedback information having language formats that are suitable for the authenticated user and provide customized feedback in lieu of or in addition to default feedbacks. Accordingly, it would be possible to support any of the estimated 6,912 main languages and 39,491 known alternate language names and dialects in the world while not requiring any modification to intelligent device 100.

In another example embodiment, information regarding handicaps or physical disabilities may be particularly useful in providing appropriate feedback for disabled users. For example, if the authenticated user is determined to be visually impaired, a simple spoken message, such as “Paper jam please contact your system administrator” may be provided so as not to encourage the blind user to start disassembling the device to look for the jammed paper.

In yet another example embodiment, the user credentials may include information regarding the user's experience in intelligent device 100 or the user's aptitude and/or ability to access, operate, or maintain intelligent device 100. Such information may be particularly useful in providing appropriate feedback for the authenticated user. For example, the level of information communicated to the authenticated user may depend on the user's technical expertise and/or experience. For example, a novice user with very little technical knowledge of intelligent device 100 may be provided with terse or simple basic feedback messages, such as “out of paper” when the media tray is empty or “the output bin is full” when there is no more available space in the output tray and all other errors or messages related to more complicated events or conditions, such as paper jams or fuser or ink/toner cartridge replacements, may be referred to the system administrator. In such example embodiments when such conditions exist, an intermediate level user may have a few more options and/or get a few more messages, and a highly technical user may be provided with verbose or complex feedback messages and/or instructions that provide solutions to the encountered errors and/or problems.

In one example aspect, customized feedback information may be associated with a single user and may result in the user having an individually customized feedback experience on intelligent device 100. In another example aspect, customized feedback information may be associated with a group of users sharing common user credentials and may result in each user of the group having the same user experience.

At block 220, processor 140 may index storage medium 120 on intelligent device 100 for future retrieval of feedback information for particular events or conditions associated with the authenticated user upon determining that one or more customized feedback information is associated with the authenticated user. It will be appreciated that since customized feedback may be input by a user according to preference, each event or condition may or may not have a corresponding customized feedback. Processor 140 may utilize the static set of default feedback stored within storage medium 120 in responding to certain events or conditions where customized feedback is unavailable or not created by the user.

At block 225, intelligent device 100 may remain in an event monitoring state after the user is authenticated and while the user is operating the device. Once an event or condition occurs, intelligent device 100 may read the one or more customized feedback information associated with the authenticated user to determine if customized feedback intended for the particular event or condition is available for the authenticated user (block 230).

Upon a positive determination, intelligent device 100 may output the customized feedback to the user at block 240 in lieu of or in addition to the default feedback for the event or condition. In one example embodiment, intelligent device 100 may be programmed during application of a customized setting by the user to override the default settings and to cause user interface 125 or output mechanism 130 to output the customized feedback associated with the authenticated user in lieu of a default feedback when a particular associated event or condition occurs. In another example embodiment, intelligent device 100 may be programmed to cause user interface 125 or output mechanism 130 to output the customized feedback associated with the authenticated user along with the default feedback when a particular associated event or condition occurs. In one aspect, a user may specify or input the order in which the customized feedback and default feedback is to be presented to the user. In another aspect, the order in which the customized feedback and default feedback is presented to the user may be preset by the manufacturer or system administrator.

In one aspect, code may be written within the firmware of intelligent device 100 to check for the existence of an entry on the storage medium 120 of an override for a default feedback message originally programmed to be output in response to the occurrence of the particular event or condition. In another aspect, the user's credentials may direct the firmware to look for an association or mapping, such as a specific location of a configuration table on the storage medium 120, where the appropriate customized feedback override may be located.

In some example embodiments, a single customized feedback may be output in lieu of a number of default feedbacks. For example, a set of error and/or warning messages may be simplified into a fewer number of succinct messages, with each succinct message covering a wide number of conditions and default feedback messages. As a more specific example, a number of default feedbacks may include paper jam messages, each of which specifies different locations where the jam occurred. To reduce the amount of technical information and/or instructions relayed to a novice user or a visually impaired user, the paper jam messages may be simplified into a single key message such as “Please contact your system administrator.”

If a customized feedback for the particular condition or event does not exist, the default feedback for the particular event or condition may be output (block 245). In some alternative embodiments, intelligent device 100 may not provide any feedback for particular events or conditions.

Intelligent device 100 may continue to monitor events or conditions and respond accordingly using the customized feedback information associated with the currently logged-in user for a predetermined time interval. Once a time-out occurs, intelligent device 100 may revert back to using the static set of default feedback information in responding to specific events or conditions.

Relatively apparent advantages and benefits of the many embodiments include, but are not limited to, allowing easy customization of feedback and enhancing user experience. As mentioned above, the present disclosure provides a simple and extremely flexible way to provide support for translated language messages. Intelligent device 100 may support many languages but may be configured to support a single language at any point in time. By providing customized feedback messages, each user may be presented with his or her own native language messages regardless of the base language of the device. Thus, a device in a certain geographic location could support a base language while at the same time provide customized feedback messages in other languages based upon the user's credentials.

Moreover, the present disclosure also provides a solution to customize feedback for the intended audience based on a user or a group of users' credentials, such as education, age or level of technical knowledge, and provides a way to simplify a large quantity of device feedback into a few key messages.

The present disclosure may also provide a way to customize feedback by varying voice gender, pitch/intonation, speed, etc., which are currently the norm within the accessibility software community. Providing a wide spectrum of configurable options is helps to ensure each user is able to fully understand the feedback being provided by intelligent device 100.

The present disclosure may also provide a way to support output to other targeted devices. For example, a previously unsupported personal tactile device may become supported by intelligent device 100 if a connection between the personal tactile device and intelligent device 100 exists and if a customized data stream is provided by intelligent device 100 to the personal tactile device. Furthermore, the present disclosure may also provide a way to customize other accessibility components of intelligent device 100. For example, display changes such as different backgrounds, magnified displays, or even reverse video display may be made to accommodate each distinct user.

In addition to improving user experience, the present disclosure also introduces the decoupling of the authentication method from the storage medium or personal device used to store and provide customized content. This way, utilization of a single personal device, such as a USB drive, to perform both authentication and providing the customized content is no longer required. By leveraging existing storage external to or within intelligent device 100 to store customized feedback information, customized feedback may be provided without the need to store customized content on or in the same personal device used for authentication.

Many modifications and other embodiments of the disclosure set forth herein will come to mind to one skilled in the art to which these disclosures pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of providing customized feedback to a user, comprising:
receiving authentication information from the user at a device
determining one or more customized feedback associated with an event and the user based upon the authentication information and
providing the determined one or more customized feedback to the user upon an occurrence of the event at the device.

2. The method of claim 1, wherein the at least one customized feedback is provided in lieu of at least one default feedback.

3. The method of claim 1, wherein the at least one customized feedback is provided in addition to at least one default feedback.

4. The method of claim 1, wherein the determining the one or more customized feedback includes identifying a customized feedback based on a user attribute.

5. The method of claim 1, further comprising storing one or more user groups within the device, each user group having a set of customized feedback.

6. The method of claim 5, further comprising identifying whether the user is included in one of the one or more user groups based upon the authentication information.

7. The method of claim 6, the one of the one or more customized feedback is selected from the customized feedback associated with the user group with which the user is associated.

8. The method of claim 4, wherein the determining the user attribute includes determining an aptitude of the user in operating the device.

9. The method of claim 1, wherein the customized feedback is at least one of a text display message, a voice message, and a customized data stream feedback.

10. The method of claim 1, wherein the customized feedback is associated with a plurality of users.

11. A method of communicating with a user, comprising:
storing at least one set of customized feedback messages in a storage medium associated with a device
obtaining a characteristic of the user operating the device
determining whether the obtained characteristic of the user corresponds to at least one characteristic specified in a distinct one of a plurality of stored user data, each stored user data including a unique set of customized feedback messages programmed to override default feedback messages upon occurrence of events relating to functions of the device and
in response to a positive determination, communicating with the user using customized feedback messages included in the distinct user data to which the user is determined to be associated with such that output feedback of the device is dependent on the characteristic of the user operating the device.

12. The method of claim 11, further comprising communicating with the user using default feedback messages, in response to a negative determination.

13. The method of claim 11, wherein the storing the at least one set of customized feedback messages includes storing a lookup table including the at least one set of customized feedback messages, each customized feedback message associated with one or more default feedback messages.

14. The method of claim 11, wherein the obtaining the characteristic of the user includes determining an aptitude of the user in operating the device such that the device communicates with the user depending on the aptitude of the user operating the device.

15. The method of claim 11, wherein the determining whether the obtained characteristic of the user corresponds to at least one characteristic specified in the distinct one the plurality of stored user data includes determining a particular user group the user is associated with.

16. The method of claim 11, wherein a single customized feedback message is output in lieu of at least one default feedback message based upon the characteristic of the user.

17. A system, comprising:
a storage medium for storing a plurality of default feedback;
an input mechanism for accepting at least one customized feedback to be stored within the storage medium and
a processor for selecting one of the at least one customized feedback based upon a user credential and outputting the at least one customized feedback to the user upon an occurrence of an event within a device.

18. The system of claim 17, further comprising a mapping stored within the storage medium, the mapping including the at least one customized feedback, wherein each customized feedback is associated with one or more default feedback.

19. The system of claim 18, wherein the processor determines the user credential upon authentication of the user and selectively outputs a customized feedback stored within the storage medium based upon the user credential.

20. The system of claim 18, wherein the mapping includes one or more user groups, each user group designated with a unique set of customized feedback, and wherein the processor processes the user credentials to identify a user group to which the user is associated to determine a customized feedback associated with the user group.
